(19) United States
(12) Patent Application Publication
(10) Pub. No.: US 2025/0133478 A1
(43) Pub. Date: Apr. 24, 2025

(54) SYSTEM AND METHOD FOR WI-FI BARRING

(71) Applicant: VERIZON PATENT AND LICENSING INC., Basking Ridge, NJ (US)

(72) Inventors: Andrew E. YOUTZ, Princeton, NJ (US); Samirkumar PATEL, Middlesex, NJ (US); Chintankumar PATEL, Edison, NJ (US)

(73) Assignee: VERIZON PATENT AND LICENSING INC., Basking Ridge, NJ (US)

(21) Appl. No.: 18/489,414

(22) Filed: Oct. 18, 2023

(51) Int. Cl. H04W 48/06; H04L 65/1016; H04W 60/04; H04W 76/10; H04W 84/12

(52) U.S. Cl. CPC H04W 48/06; H04W 60/04; H04W 76/10; H04L 65/1016; H04W 84/12

(57) ABSTRACT

Disclosed are systems and methods for a network framework for Wi-Fi barring of network usage that enables network management at a device level, which provides capabilities for the optimization of internet connectivity and data usage based on a user's and/or device's specific needs and priorities. The framework operates to handle information management system (IMS) connections and IMS registration failures over evolved Packet Data Gateways (ePDG). The framework provides a Wi-Fi backoff timer that can be implemented for particular Wi-Fi networks, which can correspond to a Wi-Fi access point (AP). Thus, a connected device (e.g., a user's smart phone) can toggle connectivity to and/or from a cellular network in accordance with encountered failures with an AP via the timer's implementation and network control of the device.

### BACKGROUND INFORMATION

Wireless Fidelity (Wi-Fi or WiFi, used interchangeably) barring is a networking feature that enables the prioritization or restriction of Wi-Fi connections for a device when in proximity to known Wi-Fi networks.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example network architecture according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates a non-limiting example embodiment of a network architecture according to some embodiments of the present disclosure; and

FIG. 5 is a block diagram illustrating a computing device showing an example of a client or server device used in various embodiments of the present disclosure.

### DETAILED DESCRIPTION OF EXAMPLE EMBODIMENTS

A “Wi-Fi barring timer” is a feature found in some mobile devices and cellular networks that enables control of the use of Wi-Fi connections for specific periods of time. According to some embodiments, such feature can be utilized to, but not limited to, save battery life, limit screen time, data usage management (e.g., switch to cellular data when you have limited data plan quotas during specific periods), security and privacy (e.g., turning off Wi-Fi when it is not in use to reduce the risk of unauthorized access to a device and/or network), and the like. Effectively, conservation and/or restriction of certain network activities during designated times can be triggered through a timer associated with Wi-Fi barring capabilities/functionality.

As discussed herein, Wi-Fi barring can correlate to functions or features of prioritization and restriction. For example, when Wi-Fi barring is enabled, a device can automatically connect to known Wi-Fi networks that have been previously connected to or designated as preferred networks. This, among other benefits, can aid in conserving cellular data and improve internet speeds. Conversely, Wi-Fi barring can also be used to restrict certain Wi-Fi networks. For example, a device can be configured to avoid connecting to public Wi-Fi networks that may be unsecured or slow, thereby ensuring that the device will primarily use its associated cellular data connection instead.

Therefore, as discussed herein, Wi-Fi barring for network usage enables network management at a device level, which provides capabilities for the optimization of internet connectivity and data usage based on a user's and/or device's specific needs and priorities.

Accordingly, in some embodiments, the disclosed systems and methods provide a novel framework that can handle Internet Protocol (IP) multimedia subsystem (IMS) connections and IMS registration failures over evolved Packet Data Gateways (ePDG). As discussed herein, according to some embodiments, the disclosed framework provides a Wi-Fi timer (or “backoff timer”) that can be implemented for particular Wi-Fi networks. In some embodiments, the timer and its associated capabilities, as discussed below, can be implemented for each Wi-Fi access point (AP), which for example, can be per a public land mobile network (PLMN) basis. Thus, according to some embodiments, a connected device (e.g., a user's smart phone) can toggle connectivity to and/or from a cellular network in accordance with encountered failures with an AP via the timer's implementation and network control of the device.

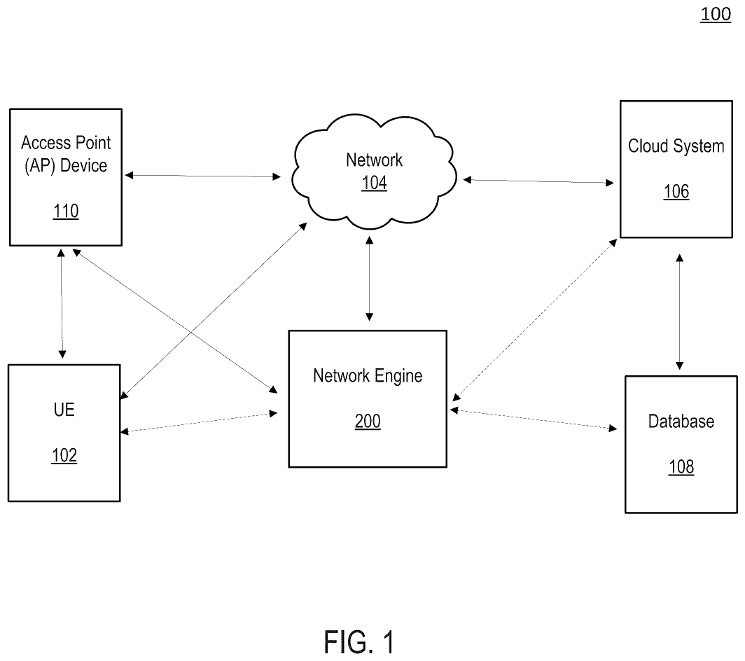

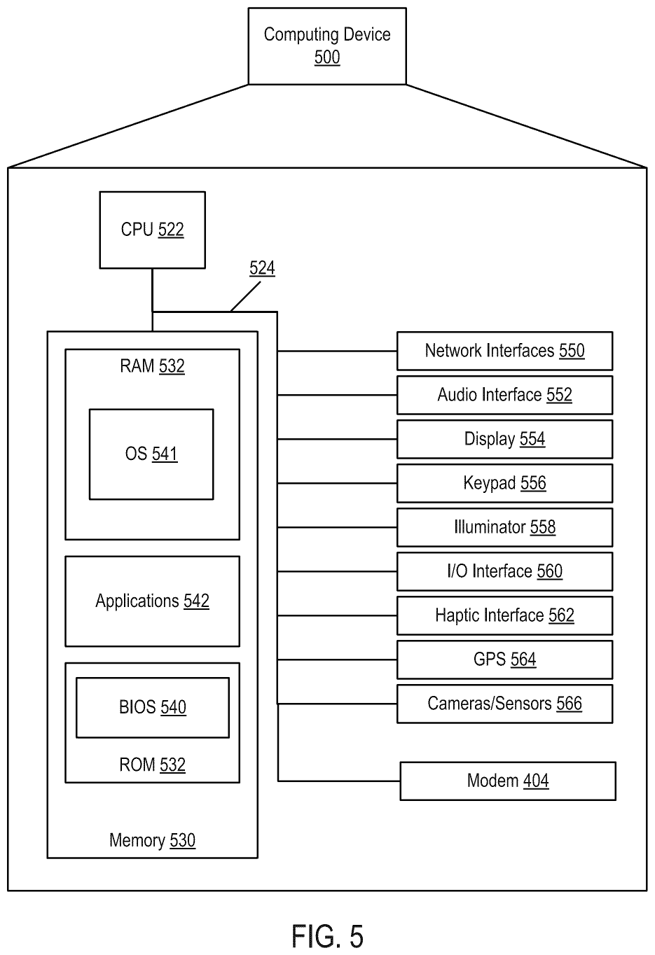

With reference to FIG. 1, system 100 is depicted which includes user equipment (UE) 102 (e.g., a client device, as mentioned above and discussed below in relation to FIG. 5), AP device 110, network 104, cloud system 106, database 108, and network engine 200. It should be understood that while system 100 is depicted as including such components, it should not be construed as limiting, the numbers of UEs, AP devices, peripheral devices, cloud systems, databases and networks that can be utilized; however, for purposes of explanation, system 100 is discussed in relation to the example depiction in FIG. 1.

According to some embodiments, UE 102 can be any type of device, such as, but not limited to, a mobile phone, tablet, laptop, game console, smart television (TV) Internet of Things (IoT) device, autonomous machine, wearable device, and/or any other device equipped with a cellular or wireless or wired transceiver.

According to some embodiments, AP device 110 is a device that creates and/or provides a wireless local area network (WLAN) for the location. According to some embodiments, the AP device 110 can be, but is not limited to, a router, switch, hub, gateway, extender and/or any other type of network hardware that can broadcast a Wi-Fi signal to a designated area. In some embodiments, UE 102 may be an AP device acting as a network extender for AP device 110 for another UE.

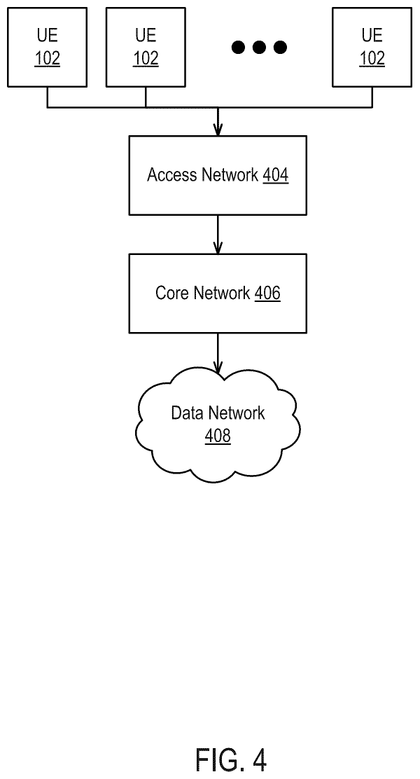

In some embodiments, network 104 can be any type of network, such as, but not limited to, a wireless network, cellular network, the Internet, and the like (as discussed above). Network 104 facilitates connectivity of the components of system 100, as illustrated in FIG. 1. Further discussion of embodiments of network 104 are provided below with reference to FIG. 4.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a cellular provider—Verizon®, which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 110, and the services and applications provided by cloud system 106 and/or network engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

According to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Network engine 200, as discussed above and further below in more detail, can include components for the disclosed functionality. According to some embodiments, network engine 200 may be a special purpose machine or processor, and can be hosted by a device on network 104, within cloud system 106, on AP device 110 and/or on UE 102. In some embodiments, engine 200 may be hosted by a server and/or set of servers associated with cloud system 106.

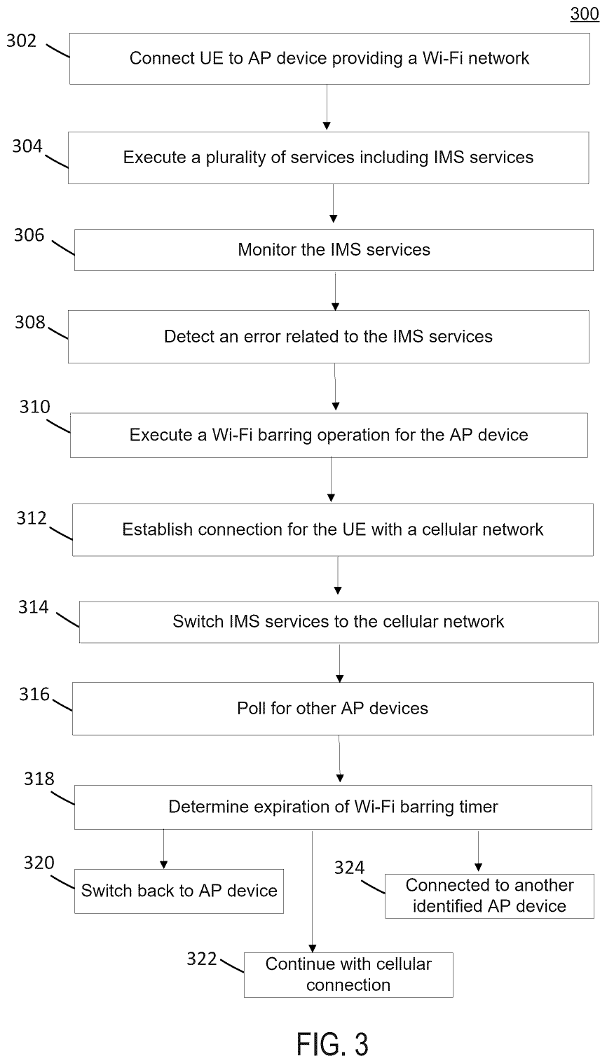

According to some embodiments, as discussed in more detail below, network engine 200 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIG. 3.

According to some embodiments, as discussed above, network engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102 (and/or AP device 110, in some embodiments. In some embodiments, such application may be a web-based application accessed by UE 102 (and/or AP device 110). In some embodiments, engine 200 may be configured and/or installed as an augmenting script, program or application (e.g., a plug-in or extension) to another application or program provided by cloud system 106 and/or executing on UE 102 and/or AP device 110.

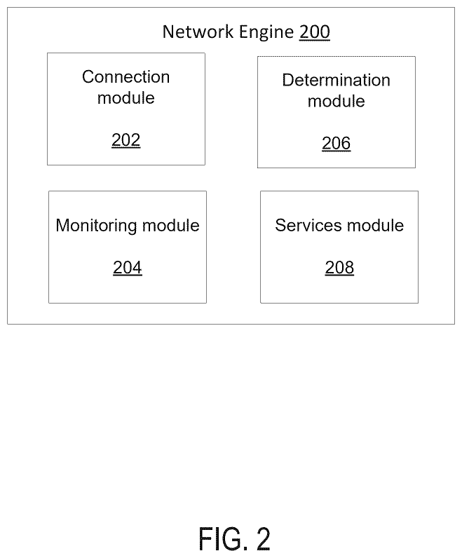

As illustrated in FIG. 2, according to some embodiments, network engine 200 includes connection module 202, monitoring module 204, determination module 206 and services module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for monitoring, controlling and managing how a device connected to a Wi-Fi network can toggle (or switch) to/from a cellular network and/or other AP devices, whether they correspond to original Wi-Fi network or another Wi-Fi network.

According to some embodiments, Steps 302, 312 and 320-324 can be performed by connection module 202 of network engine 200; Steps 304 and 314 can be performed by services module 208; Steps 306 and 310 can be performed by monitoring module 204; and Steps 308, 316 and 318 can be performed by determination module 206.

According to some embodiments, Process 300 begins with Step 302 where a UE connects to an AP device that is providing a Wi-Fi network. For example, a user's smart phone is detected as being within proximity of an AP device providing a Wi-Fi network (e.g., a user enters their home, for which they can be automatically connected). In some embodiments, such connection can involve registering and/or establishing a connection with a new Wi-Fi network, and/or any other type of manner for connecting with a Wi-Fi network.

For example, with reference to FIG. 1, in some embodiments, Step 302 can involve UE 102 establishing a connection with a packet data gateway (PDG, for example an evolved PDG (ePDG) via AP device 110, which enables UE 102 to connect to the network hosted and/or provided by AP device 100. Thus, in some embodiments, UE 102 can register and create an IMS PDG connection with AP device 110. In some embodiments, as discussed below, such IMS connection may have a time period associated therewith, which may require re-registration/re-establishment prior to its expiration.

In Step 304, a plurality of services can be executed by the UE, which can involve the IMS services. IMS services involve the delivery of multimedia communication services, such as, for example, voice, video and text messages over IP networks. Therefore, for example, voice over Wi-Fi activities can be initiated and performed by the user's smart phone. In some embodiments, such other services can be location services, application services, and the like, and/or any other type of operations/services a device can perform, whether or not they are connected to a Wi-Fi network.

In Step 306, engine 200 can execute operations to monitor the IMS services. Such monitoring can be performed according to a criteria, which can be based on, but not limited to, event detection, a time period, requests from an application program interface (API) executing on the UE, requests from the AP device, requests from a server, and the like, or some combination thereof.

In some embodiments, the monitoring of Step 306 can involve parsing and analyzing data/metadata related to the generated, downloaded, communicated and/or transmitted information from the IMS services being executed via the UE. As above, such analysis can correspond to the timing indicated by the monitoring criteria.

In some embodiments, such analysis can be performed via any type of known or to be known computational analysis technique, including artificial intelligence and/or machine learning (AI/ML) models, such as, but not limited to, feature vector analysis, decision trees, boosting, support-vector machines, neural networks, nearest neighbor algorithms, Naive Bayes, bagging, random forests, logistic regression, and the like.

In Step 308, an error (or error event) related to the IMS services can be detected. According to some embodiments, such detected error events can be related to, but not be limited to, failure of a connection, reduction in bandwidth at or below a threshold value, increase in latency at or above a threshold value, reduction of throughput at or below a threshold value, and the like, or some combination thereof.

For example, in some embodiments, such an error event can correspond to a connection failure, where, for example, an IMS certificate for the UE (e.g., “IMS establishment”) can expire. In some embodiments, such expiration can be related to, but not limited to, a time period for the IMS registration expiring without the UE re-registering, the UE moving outside range of the AP device, and the like. In some embodiments, the error may also and/or alternatively correspond to a failure to establish an IMS connection (e.g., an IMS connection to an IMS packet data network (PDN) or IMS connection to a proxy call session control function (P-CSCF), an authentication failure, and the like.

Thus, in some embodiments, the error event can correspond to and/or provide information related to an indication of insufficient network capabilities and/or capacity of the Wi-Fi network for handling the IMS services, whereby such insufficiencies are tied to the error events discussed supra.

In Step 310, upon detection of the error event (as in Step 308), a Wi-Fi barring operation can be executed. According to some embodiments, as mentioned above, Wi-Fi barring refers to an operation and/or feature in Wi-Fi networks and devices that allows for the restriction or control of Wi-Fi access based on certain criteria. According to some embodiments, such operation/feature can include, but not be limited to, a time period, location, type of IMS service, and the like. For example, Wi-Fi network connectivity for the AP device can be halted and/or prevented for a time period, where the time period's value can be a predetermined range (e.g., about 60-1023 seconds, for example), a predetermined value (e.g., 0-900 seconds/15 minutes, for example) and/or dynamically determined based on the type of error event (from Step 308). Thus, in some embodiments, the performance of Steps 312-318 can be performed during the time period of the operation of such Wi-Fi barring. In some embodiments, once the timer is started, it will run for its entirety.

According to some embodiments, the Wi-Fi barring feature can be useful in various scenarios, such as managing network access, ensuring network security, and optimizing network performance. For example, Wi-Fi barring can be utilized to, but not limited to, manage access control to a network, ensure a Quality of Service (QOS), perform band steering, perform load balancing, provide roaming control, add security measures to the network, and the like.

By way of a non-limiting example, Wi-Fi barring can be used to control which users and/or devices can connect to a Wi-Fi network. In some embodiments, this can be limited via security mechanisms, such as, but not limited to, Wi-Fi passwords (WPA/WPA2/WPA3), MAC address filtering and the like. For example, with MAC address filtering, specific devices are allowed or denied access based on their unique MAC addresses.

Moreover, Wi-Fi barring can prioritize certain types of traffic over others. For example, a network administrator may configure Wi-Fi access points to give priority to voice or video calls over web browsing or file downloads. This can aid in ensuring a better user experience for critical applications.

In some embodiments, Wi-Fi networks may operate on any Wi-Fi band (e.g., 2.4 GHz or 5 GHz bands) (e.g., via multi-link operation (MLO)). Wi-Fi barring can be used to steer devices towards one band or the other based on various criteria, such as, but not limited to, signal strength or congestion. For example, a device may be barred from connecting to the 2.4 GHz band if the 5 GHz band provides a stronger and less congested signal.

Accordingly, Wi-Fi barring can enhance network security by blocking or throttling access from devices that exhibit suspicious or malicious behavior. For example, repeated failed login attempts may trigger barring for a specific device. Thus, the disclosed Wi-Fi barring is configured as an executable tool that can manage and optimize Wi-Fi network access and performance based on specific needs and objectives of connected devices, users and/or the network.

Therefore, with reference to FIG. 1, in some embodiments, in Step 310, the executed Wi-Fi barring operation can sever the connection between UE 102 and AP device 110.

In Step 312, upon severance of the Wi-Fi connection via the Wi-Fi barring operation (in Step 310, supra), engine 200 can facilitate, enable or otherwise cause the UE to connect to a cellular network. An example and discussion of such cellular connection is discussed below with reference to FIG. 4. For example, a user's smart phone is registered with and has a cellular plan with Verizon®; therefore, such cellular subscription can be identified and utilized for the IMS services, as discussed herein.

According to some embodiments, for example with reference to FIG. 1, Step 312 can involve the UE creating and/or establishing a PDN connection with network 104, where network 104 can be a 4G/5G cellular network.

In some embodiments, the cellular network connection can occur a time proximate to the Wi-Fi barring operation. That is, a predetermined time prior to severing the Wi-Fi connection can correlate to the time the cellular network connection is established. This, therefore, can enable an overlap of connectivity so that IMS services, as well as other network related services, are not interrupted.

Thus, in Step 314, upon the establishment of the cellular connection for the UE, the IMS services (from Step 304) can be switched to the cellular network. According to some embodiments, the switching of the IMS services can involve an IMS registration and/or establishment with the PDN, which can be performed in a similar manner as discussed above in relation to at least Step 304. For example, Step 314 can involve an inter-RAT transition from the ePDG to the PDN. In some embodiments, the other services (from Step 304) can be maintained on the Wi-Fi network; and in some embodiments, such other services can also be switched to the cellular network.

In Step 316, engine 200 can cause the UE to poll for other AP devices. In some embodiments, such polling can be communicating and/or receiving signals related to other AP devices. In some embodiments, the AP devices can correspond to the same Wi-Fi network (from Step 302); and in some embodiments, the AP devices can correspond to different Wi-Fi networks. In some embodiments, instructions for the polling can indicate which type of Wi-Fi network to check for (e.g., the same or different Wi-Fi networks, and/or secure and/or public networks, for example). Such polling, as discussed below, can be utilized to determine which connection to maintain and/or pursue upon the expiration of the Wi-Fi barring timer.

In Step 318, upon the determination of the Wi-Fi barring timer, engine 200 can determine the operations/actions to perform respective to the network connection of UE. In some embodiments, as in Step 320, the UE can switch connectivity back to the AP device (from Step 302). In some embodiments, such connection can involve a new IMS registration with the ePDG if the original IMS connection has expired. In some embodiments, as in Step 322, the UE can maintain its connectivity with the cellular network (as in Step 312). In some embodiments, such connection can involve a new IMS registration with the PDN if the original IMS connection has expired. And, in some embodiments, as in Step 324, the UE can connect to another AP device that was identified via the polling (as in Step 316). In some embodiments, The connection of Step 324 to a different Wi-Fi AP device can be performed in a similar manner as discussed above at least in relation to Step 302.

In some embodiments, which connection is pursued from Step 318 can be based on a criteria, which can correspond to, but not be limited to, a type of IMS service, availability of the original Wi-Fi network, availability of other Wi-Fi networks, signal strength of any of the available Wi-Fi and/or cellular networks, location of the device, type of device, and the like, or some combination thereof. In some embodiments, such determination can be performed via any of the AI/ML techniques discussed above.

According to some embodiments, upon the performance of Step 320, 322 or 324, engine 200 can recursively proceed back to Step 306, where the IMS services can be monitored and analyzed for the current network connection.

FIG. 4 is a block diagram of an example network architecture according to some embodiments of the present disclosure. In the illustrated embodiment, UE 102 accesses a data network 408 via an access network 404 and a core network 406.

In the illustrated embodiment, the access network 404 comprises a network allowing network communication with UE 102. In general, the access network 404 includes at least one base station that is communicatively coupled to the core network 406 and coupled to zero or more UE 102.

In some embodiments, the access network 404 comprises a cellular access network, for example, a 5G network. In an embodiment, the access network 404 can include a NextGen Radio Access Network (NG-RAN). In an embodiment, the access network 404 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 404 provides access to a core network 406 to the UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 406 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 406 and to external network-attached elements in a data network 408 such as the Internet.

In the illustrated embodiment, the access network 404 and the core network 406 are operated by a NO. However, in some embodiments, the networks (404, 406) may be operated by a private entity and may be closed to public traffic. For example, the components of the network 406 may be provided as a single device, and the access network 404 may comprise a small form-factor base station. In these embodiments, the operator of the device can simulate a cellular network, and UE 102 can connect to this network similar to connecting to a national or regional network.

In some embodiments, the access network 404, core network 406 and data network 408 can be configured as a multi-access edge computing (MEC) network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

FIG. 5 is a block diagram illustrating a computing device showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, GPS receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a CPU 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) 540 for controlling the low-level operation of the computing device 500. The mass memory also stores an operating system 541 for controlling the operation of the computing device 500.

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
connecting a device to an access point (AP) device associated with a Wi-Fi network, the connection enabling the device access to the Wi-Fi network;
executing, over the Wi-Fi network, Internet Protocol multimedia subsystem (IMS) services for the device;
detecting an error event related to the IMS services being executed over the Wi-Fi network, the error event comprising an indication of insufficient network capacity of the Wi-Fi network for handling the IMS services;
executing, based on the detection of the error event, a Wi-Fi barring timer, the Wi-Fi barring timer halting the connection of the device with the Wi-Fi network for a time period;
establishing a connection for the device with a cellular network; and
switching the IMS services for the device to the cellular connection.

2. The method of claim 1, further comprising:
switching, upon expiration of the time period of the Wi-Fi barring timer, IMS services back to the Wi-Fi network.

3. The method of claim 1, further comprising:
polling for other AP devices;
identifying another AP device based on the polling of the other AP devices; and
switching connectivity of the device to the other AP device.

4. The method of claim 1, wherein the IMS services correspond to multimedia communication services, wherein the multimedia communication services comprise at least one of voice, video and text messages.

5. The method of claim 1, wherein the error event corresponds to at least one of an expiration of an IMS certificate, failure of the Wi-Fi connection, reduction in bandwidth of the Wi-Fi connection at or below a threshold value, increase in latency of the Wi-Fi connection at or above a threshold value, reduction of throughput of the Wi-Fi connection at or below a threshold value, failure to establish an IMS connection and an authentication failure.

6. The method of claim 1, further comprising:
registering with an evolved packet data gateway (ePDG), wherein the connection with the Wi-Fi network is based on the registration with the ePDG.

7. The method of claim 1, further comprising:
registering with a packet data network (PDN), wherein the connection with the cellular network is based on the registration with the PDN.

8. The method of claim 1, further comprising:
executing additional services over the Wi-Fi network.

9. The method of claim 8, wherein the additional services are maintained on the Wi-Fi network regardless of the switching of the IMS services.

10. The method of claim 8, further comprising:
switching the additional services to the cellular network with the IMS services.

11. The method of claim 1, wherein the device is a user device.

12. A user equipment (UE) device comprising:
a processor configured to:
connect to an access point (AP) device associated with a Wi-Fi network, the connection enabling the device access to the Wi-Fi network;
execute, over the Wi-Fi network, Internet Protocol multimedia subsystem (IMS) services;
detect an error event related to the IMS services being executed over the Wi-Fi network, the error event comprising an indication of insufficient network capacity of the Wi-Fi network for handling the IMS services;
execute, based on the detection of the error event, a Wi-Fi barring timer, the Wi-Fi barring timer halting the connection with the Wi-Fi network for a time period;
establish a connection with a cellular network; and
switch the IMS services to the cellular connection.

13. The UE device of claim 12, wherein the processor is further configured to:
switch, upon expiration of the time period of the Wi-Fi barring timer, IMS services back to the Wi-Fi network.

14. The UE device of claim 12, wherein the processor is further configured to:
poll for other AP devices;
identify another AP device based on the polling of the other AP devices; and
switch connectivity of the device to the other AP device.

15. The UE device of claim 12, wherein the processor is further configured to:
register with an evolved packet data gateway (ePDG), wherein the connection with the Wi-Fi network is based on the registration with the ePDG.

16. The UE device of claim 12, wherein the processor is further configured to:
register with a packet data network (PDN), wherein the connection with the cellular network is based on the registration with the PDN.

17. The UE device of claim 12, wherein the processor is further configured to:
execute additional services over the Wi-Fi network.

18. The UE device of claim 12, wherein the additional services are maintained on the Wi-Fi network regardless of the switching of the IMS services.

19. The UE device of claim 12, wherein the processor is further configured to:
switch the additional services to the cellular network with the IMS services.

20. A non-transitory computer-readable storage medium storing instructions, executable by a device, wherein the instructions are configured to:
connect the device to an access point (AP) device associated with a Wi-Fi network, the connection enabling the device access to the Wi-Fi network;
execute, by the device, over the Wi-Fi network, Internet Protocol multimedia subsystem (IMS) services;
detect, by the device, an error event related to the IMS services being executed over the Wi-Fi network, the error event comprising an indication of insufficient network capacity of the Wi-Fi network for handling the IMS services;
execute, by the device, based on the detection of the error event, a Wi-Fi barring timer, the Wi-Fi barring timer halting the connection with the Wi-Fi network for a time period;
establish, by the device, a connection with a cellular network; and
switch, by the device, the IMS services to the cellular connection.
